(19) United States
(12) Patent Application Publication
(10) Pub. No.: US 2024/0341224 A1
(43) Pub. Date: Oct. 17, 2024

(54) Slope Mower

(71) Applicant: Metalcraft of Mayville, Inc., Mayville, WI (US)

(72) Inventors: Joseph Patzer, Fond du Lac, WI (US); Shawn Trice, Menasha, WI (US)

(21) Appl. No.: 18/626,504

(22) Filed: Apr. 4, 2024

Related U.S. Application Data
(60) Provisional application No. 63/458,760, filed on Apr. 12, 2023.

(51) Int. Cl. A01D 34/86; A01D 34/00; A01D 34/66; A01D 101/00

(52) U.S. Cl. CPC A01D 34/86; A01D 34/008; A01D 34/66; A01D 2101/00

(57) ABSTRACT

A slope mower includes a frame; a prime mover, typically an IC engine; opposed ground supports, typically tracks, supporting opposed lateral side portions of the frame on the ground; and a cutter deck. The cutter deck has four rotating cutting blade assemblies. The cutting blade assemblies are arranged in a non-rectangular quadrilateral pattern when viewed in bottom plan, permitting at least essentially equal operation when mowing in either the forward or reverse direction. The rotational axes of the front and rear cutting blade assemblies may lie on a line that is offset from a longitudinal centerline of the cutting deck. The cutting blades may be powered by dedicated electric motors. The prime mover and electric motors may be mounted on the cutter deck.

### CROSS-REFERENCE TO A RELATED APPLICATION

This application claims priority under 35 USC § 119 (e) to U.S. provisional application Ser. No. 63/458,760, filed Apr. 12, 2023 and entitled SLOPE MOWER, the continues of which are hereby incorporated by reference in their entirety.

### FIELD OF THE INVENTION

The invention relates generally to turf maintenance machines and, in particular, to a mower configured to cut vegetation on steep slopes. The invention relates to a cutting deck for such a mower and to a method of operating such a mower.

### BACKGROUND OF THE INVENTION

“Slope mowers” are well known for cutting grass, weeds, brush, and other vegetation on steep slopes. They typically take the form of a self-propelled vehicle supported on the ground by wheels or tracks. The vehicle includes a frame supporting a cutter deck having from one to three cutting blade assemblies. Most slope mowers are remote controlled.

The typical slope mower is configured to operate on a slope of up to 50°. The mower may be controlled to mow either laterally or cross-wise of the slope, or longitudinally or up and down the slope. Most such slope mowers are remotely controlled. In operation, the slope mower typically is controlled to move back and forth along parallel passes in a first direction (hereafter the “X” direction) in passes that are adjacent to each other in the opposed direction (hereafter the “Y” direction.) The X direction selected for a particular pass may be longitudinally or up and down the slope, horizontally or along the side of the slope, or at an inclined angle relative to the slope.

Many slope mowers are fitted with cutter decks mounted centrally of a frame between the opposed tracks or wheels. Such slope mowers have from one to three cutting blades and a cutting swath of about 26″ to about 72″. The typical “larger” cutter deck has a cutting swath of 48″ or more typically has three cutting blade assemblies. The cutting blade assemblies of the typical three-cutting blade assembly cutter deck are arranged in a V-formation, with a center cutting blade assembly positioned in front of left and right cutting blade assemblies. This blade arrangement tends to produce poor cutting results when the mower mows in reverse for reasons discussed below. The typical three cutter-blade assembly mower therefore is controlled only to cut in the forward direction, also for reasons described in detail below, requiring a sharp Y-turn at the end of each pass. Turning a vehicle in such a manner tends to tear up the ground. This is particularly true in the case of a tracked vehicle, since the tread presents a relatively large, rough surface that pivots or slides along the ground during a turn.

The cutting blade assemblies of the typical multi-bladed slope mower also typically are driven by a belt coupled to a driveshaft of the mower's internal combustion-powered engine. This type of drive arrangement prevents or limits the controlled supply of differential power delivered to the various cutting blade assemblies. The drive power for the individually blades therefore cannot be adapted to a given set of cutting conditions to optimize quality of cut. Thus, in the case of a slope mower having a three-bladed cutter deck, one cutting blade assembly experiencing a heavier load than the others due, for example, to the encountering of thicker or tougher vegetation than that encountered by the other cutting blade assemblies, may bog down the entire mower and/or fail to provide a good quality cut.

The need therefore has arisen to provide a multi-cutting blade assembly slope mower that is capable of operating effectively in both the forward and reverse directions.

The need additionally has arisen to provide a multi-cutting blade assembly slope mower in which the power delivered to the various blades can be modified relative to one another during a cutting operation to optimize cut quality.

### SUMMARY OF THE INVENTION

In accordance with an aspect of the invention, one or more of these needs is met by providing a slope mower with a frame, a prime mover (typically an IC engine), opposed ground supports (typically tracks or wheels) supporting opposed sides of the frame on the ground and powered by the prime mover, and a cutter deck. The cutter deck includes four cutting blade assemblies arranged in a generally diamond shaped pattern, i.e., in a non-rectangular quadrilateral pattern, when viewed in bottom plan.

The cutting blade assemblies may include first and second cutting blade assemblies disposed on opposed sides of a longitudinal centerline of the cutter deck, and third and fourth cutting blade assemblies located laterally between the first and second cutting blade assemblies and positioned in front of and behind a line connecting axes of rotations of the first and second cutting blade assemblies, respectively.

Each of the third and fourth cutting blade assemblies may have an axis of rotation positioned on a longitudinal centerline of the cutter deck.

Alternatively, a line connecting the axes of rotation of the third and fourth cutting blade assemblies may be offset relative to a longitudinal centerline of the cutter deck. That offset is typically between 5° and 15°, and more typically between 7° and 8°.

The slope mower may be a hybrid vehicle having an alternator that is coupled to the internal combustion engine and having a battery bank that is charged by the alternator. In this case, at least one electric motor may be provided that drives the cutting blade assemblies to rotate. In one possible configuration, first through fourth electric motors are provided, with each motor being configured to drive a dedicated one of the first through fourth cutting blade assemblies. Controls for this vehicle may include a main vehicle controller and first through fourth subcontrollers, each of which controls the power supply from the battery bank to a respective one of the electric motors. The engine, battery bank, and electric motors may be mounted on the cutter deck. This permits individual control of the power supply to each cutter blade.

The slope mower may be remote controlled.

Also provided is a cutter deck usable in a slope mower having at least some of the features described above.

Also provided is a method of operating a slope mower having at least some of the characteristics described above.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof.

### BRIEF DESCRIPTION OF THE DRAWINGS

An exemplary embodiment of the invention is illustrated in the accompanying drawings in which like reference numerals represent like parts throughout, and in which:

FIG. 1 is a top front perspective view of a slop mower constructed in accordance with the invention;

FIG. 2 is a bottom isometric view of a slope mower of FIG. 1;

FIG. 3 is a top plan view of the slope mower of FIGS. 1 and 2;

FIG. 4 is a front elevation view of the slope mower of FIGS. 1-3;

FIG. 5 is a side elevation view of the slope mower of FIGS. 1-4;

FIG. 6 is a schematic of the powered components of the slope mower of FIGS. 1-5;

FIG. 7 schematically illustrates the geometry of a four-cutting blade assembly cutter deck having its cutting blade assemblies arranged in a first geometric configuration;

FIGS. 8 and 9 schematically illustrate the turning of a slope mower having its cutting blade assemblies arranged in the configuration of FIG. 7 in a right turn and a left turn, respectively;

FIG. 10 schematically illustrates the geometry of a four-cutting blade assembly cutter deck having its cutting blade assemblies arranged in a second geometric configuration;

FIG. 11 schematically illustrates the turning of a slope mower having its cutting blade assemblies arranged in the configuration of FIG. 10 in either a right turn or a left turn;

FIG. 12 schematically illustrates the geometry of a three-cutting blade assembly cutter deck; and

FIG. 13 schematically illustrates the turning of a slope mower having its cutting blade assemblies arranged in the configuration of FIG. 12 in either a right turn or a left turn.

### DETAILED DESCRIPTION

By way of non-limiting example, a slope mower will now be described that is constructed in accordance with the invention. The slope mower is configured to cut grass, brush, or other vegetation on a relatively steep slope from 30° up to 50° or even more. This particular slope mower is configured to cut a relatively wide swath of approximately 52″, but could be configured to cut narrower or wider swaths as well, typically ranging from 36″ to 72″. It is also remote controlled, though at least aspects of the invention apply to riding or stand-on mowers as well.

Referring initially to FGS. 1-5, the slope mower 20 includes a frame 22 supported on the ground by left and right ground supports 24 and 26. A cutter deck is 28 is mounted on the frame 22 so as to be vertically movable of the frame 22 between the ground supports 24 and 26. The outer edges of the cutter deck 30 typically will be disposed within a few inches of inner edges of the ground supports 24 and 26. A prime mover 28 is mounted on an upper surface of the cutter deck 28 between the ground supports 24 and 26. In accordance with an embodiment of the invention, the cutter deck 30 supports four cutting blade assemblies 100A-100D arranged in a non-rectangular quadrilateral shape, or “a diamond shape”, when viewed in bottom plan. A drive system, shown as separate components described in more detail below, transmits motive power directly or indirectly from the prime mover 28 to the ground supports 24 and 26 and to the cutting blade assemblies 100A-100D.

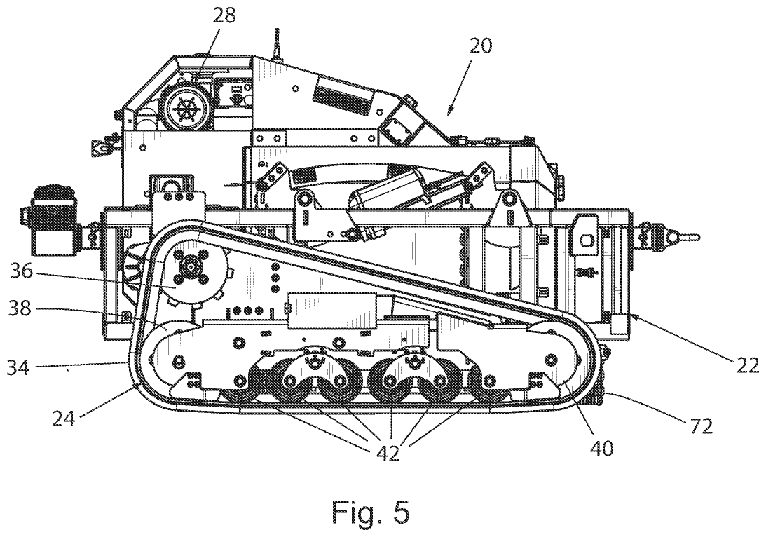

The ground supports 24 and 26 could be wheel sets. However, in the illustrated embodiment, the ground supports comprise track assemblies forming a crawler. Referring especially to FIG. 5, each track assembly 24 or 26 includes a driven endless tread or belt 34 that rides over an upper rear driven roller 36, rear and front lower idler rollers 38 and 40, and a number of smaller idler rollers or bogies 42 positioned between the rear and front rear idler rollers 38 and 40. The slope mower 20 is propelled by applying a rotational drive force to the driven rollers 36 and is steered by driving the driven rollers 36 of the respective track assemblies 24 and 26 at different speeds and even in opposite directions (i.e., forward or reverse). The track assemblies 24 and 26 may be of standard construction and, thus, need not be described in further detail.

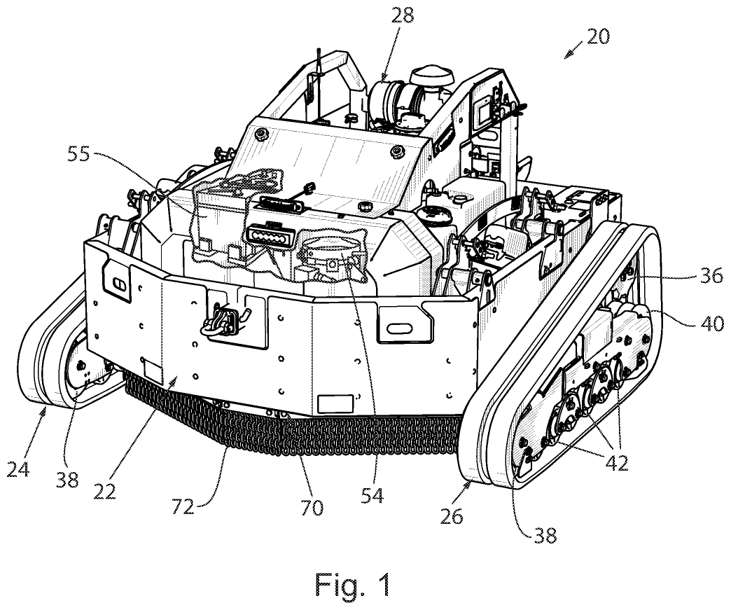

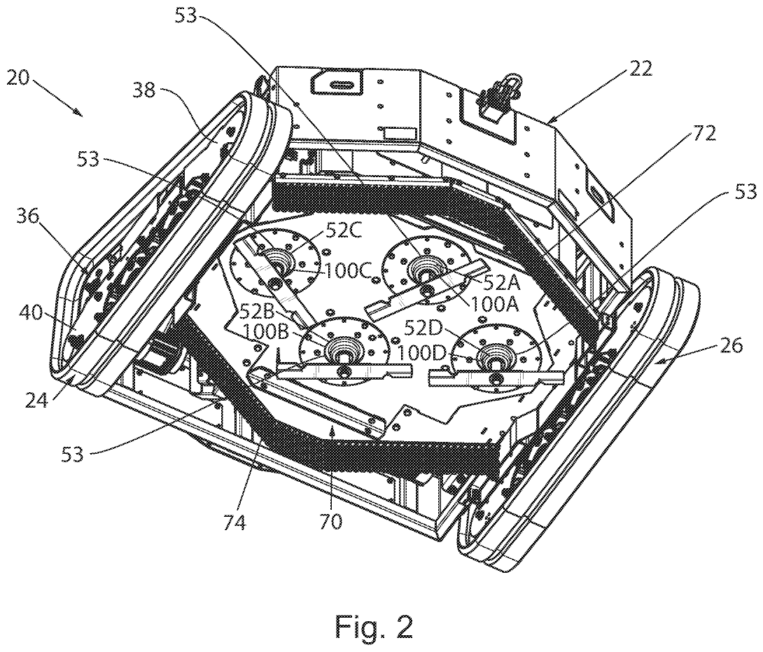

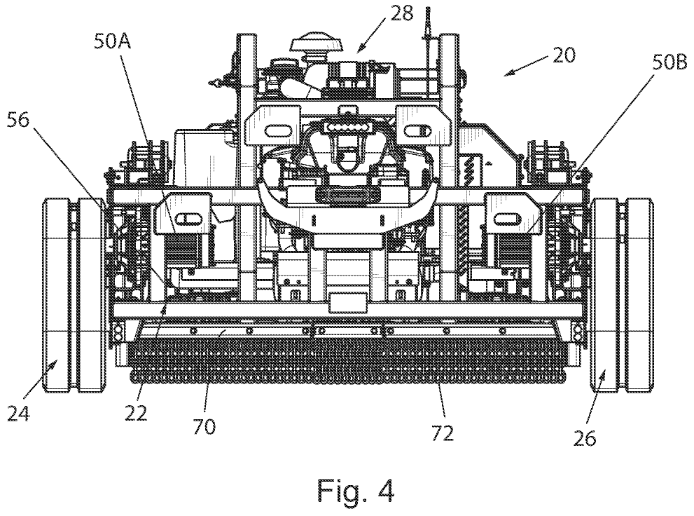

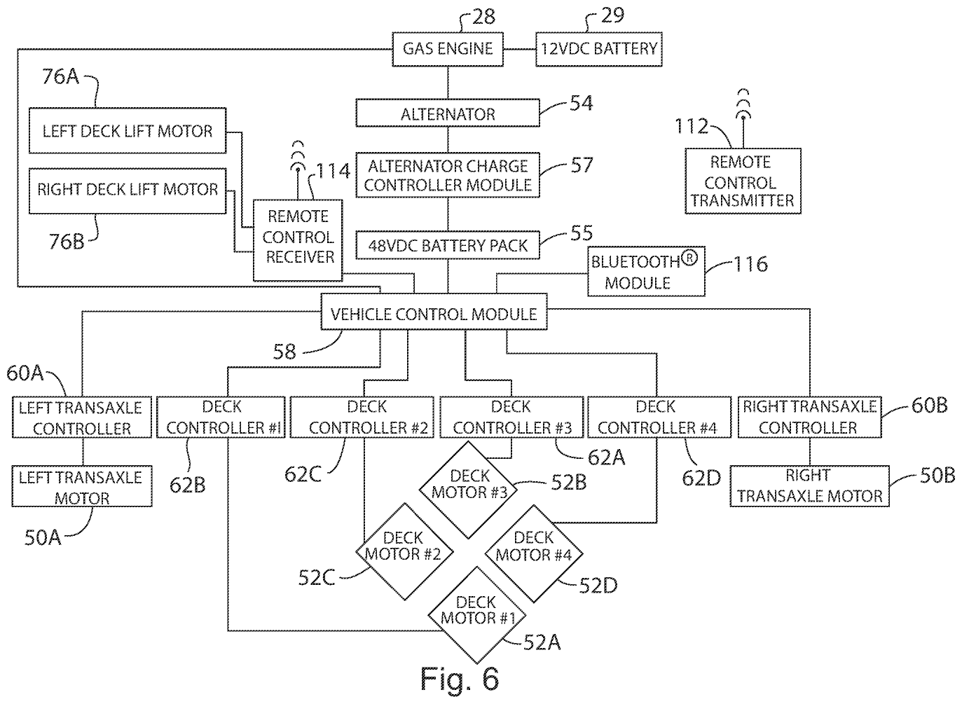

Still referring to FIGS. 1-5, the prime mover 28 comprises an internal combustion engine that is configured to at least indirectly drive the driven rollers 36 of the track assemblies 24 and 26 and the cutting blade assemblies of the cutter deck 30. The engine 28 may have a dedicated 12-volt battery 29 (FIG. 6) that supplies electrical power to the engine 28 independently of power supplied to the remaining components. In the present case, the engine 28 may be a gasoline powered engine having a rated power of 30 to 40 HP and, more typically, of 33-37 HP. The drive system coupling the engine 28 to the driven rollers 36, and even to the cutting blade assemblies 100A-100D, may be a mechanical system, typically including belts. However, the illustrated drive system comprises a so-called “hybrid” drive system including one or more electric motors that are powered indirectly by the engine 28. In the illustrated embodiment, these electric motors include first and second main drive motors 50A and 50B that are supported on the frame 22. Each of the main drive motors 50A and 50B is coupled to the driven roller 36 of a respective track assembly 24 or 26. The electric motors may also include a dedicated cutting blade assembly drive motor 52A-52D mounted on the cutter deck 30, each of which is associated with a respective cutting blade assembly 100A-100D. Each cutting blade assembly drive motor 52A-52D may have a rated power output of 1 kW to 5 KW and, more typically, between 1.5 kW and 3 KW. For the sake of conciseness, any description that will apply equally to both main drive motors will simply use the denotation “50”. Similarly, any description that applies equally to all cutting blade assembly drive motors will simply use the denotation “52”. The qualifiers “A”, “B”, etc. will be used when attention is to be directed to a specific drive motor. Any or all of the drive motors 50 and 52 may have an output shaft coupled directly to an input shaft of the associated driven device, negating the need for belts, chains, or other torque transfer mechanisms. Motors suitable for use as one or both of the main drive motors 50 and the cutting blade assembly drive motors 52 are commercially available from a variety of manufacturers including, for example, from Hydro-Gear, Howland Technologies, Inc., Omni Powertrain Technologies, and Accelerated Systems, Inc.

Each drive motor 50, 52 is supplied with electrical power from a battery bank that is charged by an alternator 54, which also charges battery 29. The battery bank and alternator 54 are mounted on the cutter deck 30. Referring briefly to FIG. 6, the battery bank is shown at 55 and is connected to the alternator 54 by an alternator charge controller module 57 that prevents overcharging of the battery bank 55. As is typical with hybrid systems, the alternator 54 is powered by the engine 28 and delivers charging power to the battery bank 55 which, in turn, provides motive power to the drive motors 50 and 52. The power ratings of the alternator 54 and the battery bank 55 may vary with many factors, including but not limited to: the size (cutting width) of the slope mower 20, the desired propulsion forces to be delivered by the main drive motors 50, and the desired cutting forces to be delivered by the cutting blade drive motors 52. For example, the alternator 54 may have a rated power output of 6-9 kW, more typically of 7-8 KW, and most typically of about 7.4 KW at 56 volts nominal. The battery bank 55 may have a power output of 4-10 KW. In the present example, battery bank 55 has a rated power output of 6 kW. The battery bank 55 is formed from two 48V batteries 56, each having a power rating of 3 kW. Of course, fewer or more batteries providing the same or different rated power outputs could be employed. Referring again to FIGS. 1-5, the batteries 56 of battery bank 55 may be distributed in such a manner that their weight tends to cause the center of gravity of the slope mower to coincide with the geometric center of the slope mower 20.

Referring to FIG. 6, power transfer from the battery bank 55 to the drive motors 50 and 52 is controlled by a vehicle control module or “master vehicle controller” 58 and subcontrollers. These subcontrollers include two transaxle controllers 60A, 60B, each associated with a main drive motor 50A, 50B of an associated track assembly 24 and 26. These subcontrollers 60A and 60B can be controlled to cause the main drive motors 50A and 50B to rotate at different speeds and even in different directions. The subcontrollers additionally include a number (four in this example) of cutting blade assembly motor controllers 62A-62D, each of which is associated with a respective cutting blade assembly drive motor 52A-52D. Separate subcontrollers are provided for each electric motor in order to ensure a uniform velocity output from each motor of each set despite varying load conditions as discussed in greater detail below. Such controllers are known in the art and available, for example, from Hydro-Gear LLC of Sullivan, IL. Alternatively, fewer subcontrollers 62 could be provided, each of which controls the power supply to two or more cutting blade assembly drive motors.

Referring again to FIGS. 1-5, the cutter deck 30 includes a flat, horizontally-extending upper plate 70 and front and rear guards 72 and 74 that extend downwardly from the upper plate 70. The front and rear guards 72 and 74 may comprise rigid skirts but, more typically, can deflect or flex to permit the mower 20 to pass over rocks, stumps, etc. while still inhibiting debris from being flung out from in front of or behind the mower 20. Each guard 72 and 74 comprises a chain that is suspended from the upper plate 70 in the illustrated example. Side guards may be provided as well, or may be omitted if the tracks 24 and 26 also can serve as guards. The upper plate 70 may be formed from steel, possibly reinforced with one or more other plates or upper struts or other supports on its upper surface, so long as it is strong enough to support the remainder of the cutter deck 30, the cutting blade assemblies 100A-100D, and the cutting blade assembly drive motors 52. The cutter deck 30 may be fixed in place relative to the frame 22. In the illustrated example, the cutter deck 30 is suspended from the frame 22 and can be raised and lowered relative to the frame 22 by electrically actuated lift arms (not shown) powered by lift motors 76A and 76B (FIG. 6).

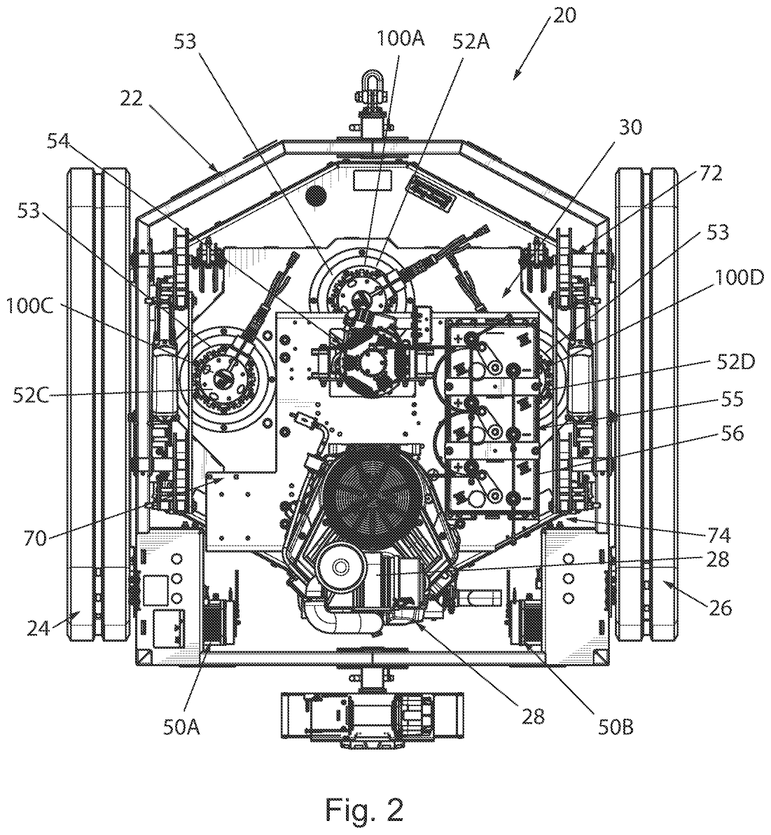

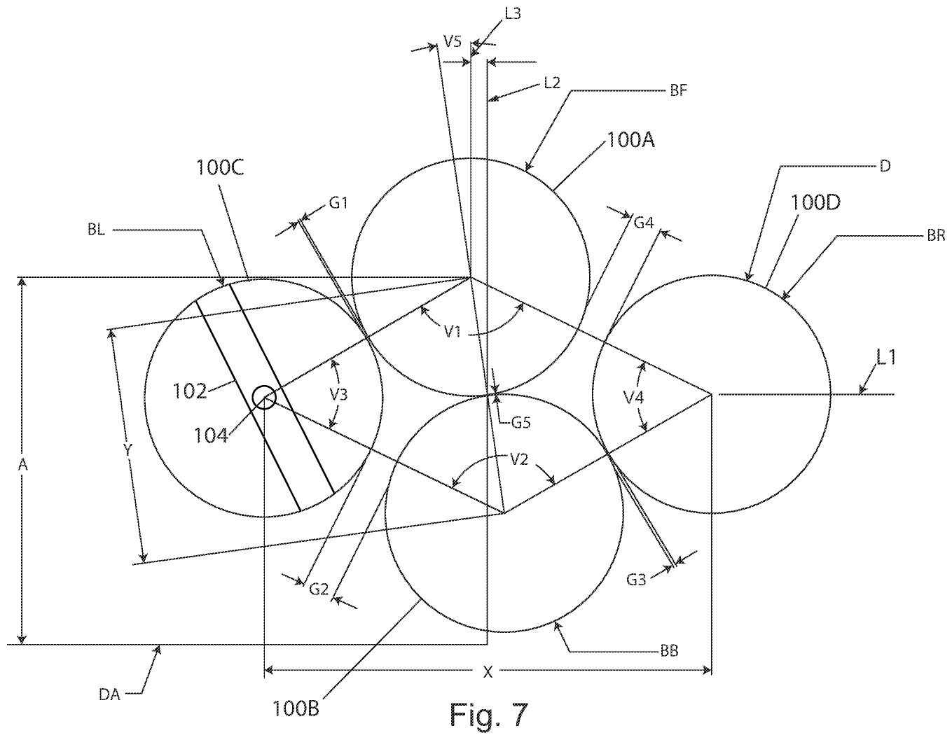

Referring briefly to FIG. 7, each cutting blade assembly 100A-100D includes a horizontally extending cutting blade 102 mounted on a spindle 104. Only one such cutting blade 102 and spindle 104 are shown in FIG. 7 in association with blade assembly 100C, it being understood that identical cutting blades and spindles would be provided with the other cutting blade assemblies 100A, 100B, and 100D. The spindles 104 extend downwardly from the plate 70 of the cutter deck 30. Referring to FIG. 3, in the illustrated embodiment, the cutting blade assembly drive motor 52 associated with each cutting blade assembly 100 is mounted over an associated opening 53 in the top plate 70 to facilitate direct connection of the spindle 104 of the associated cutting blade assembly 100 to the associated motor output. Each cutting blade 102 may have a length of 12-24 inches and, more typically, of 18 inches.

All of the powered components described above, as well as the controllers described above, are shown schematically in FIG. 6 to facilitate an understanding of the capabilities of the slope mower 20. For example, since each of the four cutting blade assembly drive motors 52A-52D is controlled by a dedicated subcontroller 62A-62D in communication with the main vehicle controller 58, the power supply to the motors 52A-52D for the individual cutting blade assemblies 100A-100B may be controlled independently of the power delivered to the other cutting blade assemblies to optimize the quality of the cut. For example, if one of the cutting blade assemblies encounters particularly thick or heavy vegetation, the power supply for that cutting blade assembly can be increased relative to the power supply for the drive motors for the remaining cutting blade assemblies to prevent or inhibit the mower from bogging down. This variation may be performed automatically in response to sensed variations in current draw by the associated cutting blade assembly drive motor. As another example, one or more of the cutting blade assemblies drive motors could be shut off depending on vehicle travel direction. For example, it is conceivable that the rear cutting blade assembly motor 52B could be shut off during forward travel and the front cutting blade assembly drive motor 52A could be shut off during reverse travel. Instead of or in addition to these controls being based on travel direction, one or more of the blade assembly drive motors 52A-52D could be turned off based, for example, on load as detected by current draw of the blade assembly drive motors 52A-52D or otherwise.

Also shown in FIG. 6 but not in FIGS. 1-5 are a remote controller 112 located off-board the mower 20 and a remote control receiver 114 located on-board the mower. The remote control receiver 114 is in communication with the vehicle main controller 58 and with the left and right deck lift motors 76A and 76B. The remote controller 112 may be a hand-held module having a transceiver with a range of 1000 feet or more, permitting the operator to control the mower 20 from a safe location away from the sloped surface to be mowed. The module of the remote controller 112 may support controls such as one or more joysticks, knobs, and/or switches that permit an operator to control 1) raising and lowering of the cutter deck 30 through control of the deck lift motors 76, 2) propulsion and steering of the track assemblies 24, and 26 through control of the main drive motors 50, and 3) control of the cutting blade assembly drive motors 52. The main vehicle controller 58 may be configured to perform other functions automatically depending on prevailing operating conditions. For example, the main vehicle controller 58 may be configured to permit only slow-speed machine operation on startup and/or to shut down the slope mower 20 entirely if a loss of signal is detected at the receiver 114. It may also cause the engine 28 to shut down if the traveled slope exceeds a maximum value of, for example, 50°. The cutting blade assembly drive motor control may be a simple on-off command that is transmitted to all cutting blade drive motor controllers 62, or may be a more sophisticated command that varies the speed of one or more cutting blade assembly drive motors relative to the other(s) or even permits the operator to shut off one or more of the blade assembly drive motors 52, which could be useful in response to observed load or discharge conditions. The remote controller 112 also may include one or more audible or visual displays conveying information about the status of one or more components of the slope mower 20 using information transmitted to the remote controller 112 from the remote control receiver 114. The displayed information may also include diagnostic information.

Finally, a Bluetooth® communications module 116 or other communication system may be provided in communication with the main vehicle controller 58 to permit technicians to interface with the module 116 for diagnostic and repair purposes and to permit the installation of firmware and software upgrades and/or setup of the slope mower 20. The module 116 also may permit at least limited access by an operator for informational or diagnostic purposes.

To recap, the cutter deck 30 has four blade assemblies 100A-100D arranged to collectively cut a 52″ swath. The cutting blade assemblies 100A-100D have their respective centers of rotation arranged to produce a “diamond” or non-rectangular-quadrilateral shape when viewed in bottom plan. Possible locations of the cutting blade assemblies 100A-100D relative to each other and relative to the slope mower 20 as a whole now will be described.

Turning now to FIG. 76, one possible geometric arrangement of a four cutting blade assembly system of the type described above is illustrated. Rotation of the cutting blades 102 of the front, rear, left, and right cutter blade assemblies 100A, 100B, 100C, and 100D circumscribes circles BF, BB, BL, and BR, respectively. The axes of rotation of the left and right blade assemblies 100C and 100D lie on a line L1 and are disposed equidistantly from a longitudinal centerline L2 of the cutter deck 30. The line L1 extends along the effective drive axis DA of the slope mower 20, which generally corresponds to the longitudinal center of the tracks 24 and 26 of the illustrated tracked vehicle or along the driven wheel axis of a wheeled vehicle, if the tracks 24 and 26 were to be replaced by wheel sets. DA is parallel with the lateral centerline of the slope mower 20. The axes of rotation of the front and rear cutting blade assemblies 100A and 100B lie on a line L3 that is offset from the longitudinal centerline L2 of the vehicle by an offset angle V5 of from 5-10°, more typically of 6-8°, and most typically of 7.73°. With that “most typical” offset, that and remaining dimensions noted in FIG. 7 are as follows:
A=28.1″, longitudinal distance from center of BF to the line L2;
C=1.2, lateral distance from the center of BF to the vehicle longitudinal centerline CL;
Y=18.2″, distance from BF to BB;
X=34.0″; distance from BL to BR;
D=18.0″, diameter of BL, BR, BF, BB;
V1=1240.°; inclusion angle between the centers of BL and BR about the center of BF;
V2=124.0°, inclusion angle between the centers of BL and BR about the center of BB;
V3=56.0°, inclusion angle between the centers of BF and BB about the center of BL;
V4=56.0°, inclusion angle between the centers of BF and BB about the center BR;
V5=7.7°, offset angle of the line L3 connecting the centers of BF and BB from the longitudinal centerline L2 of the slope mower;
G1=0.2″, the gap between BL and BF;
G2=2.3″, the gap between BL and BB
G3=0.2″, the gap between BB and BR;
G4=2.3″ the gap between BR and BF; and
G5=0.2″, the gap between BF and BB.

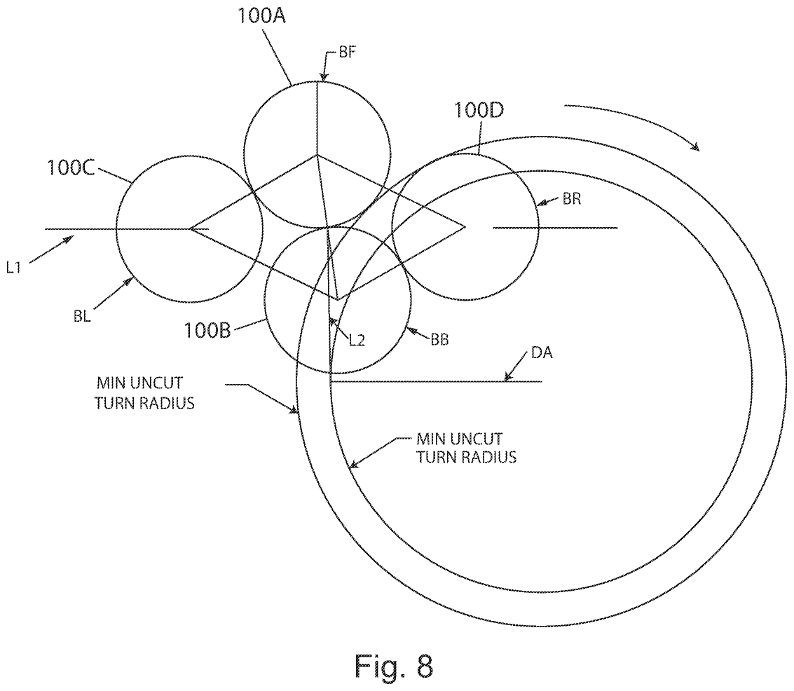

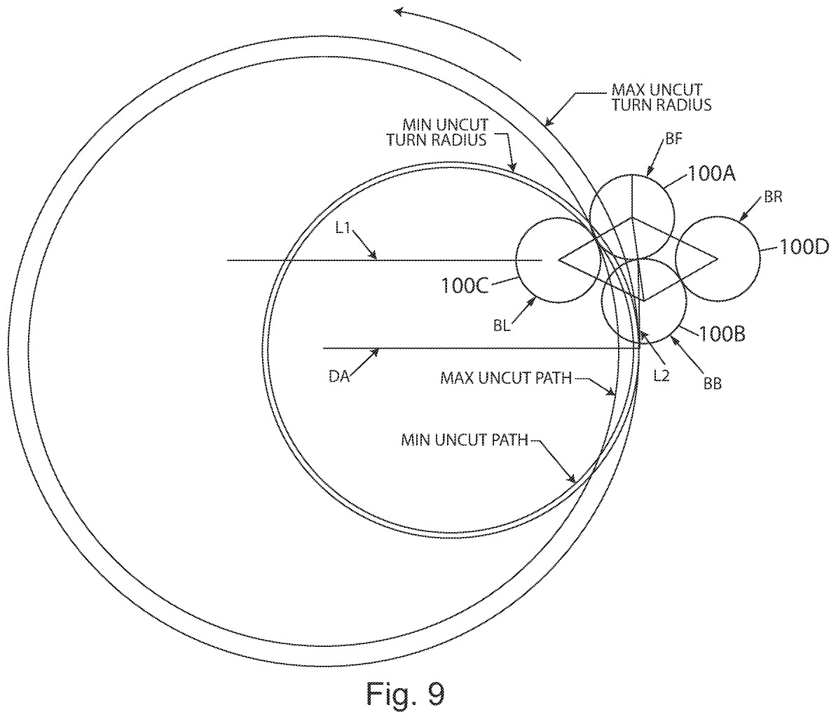

It can be seen from the foregoing that the offset angle V5 creates relatively large gaps G2 and G5 between the circles circumscribed by the left and rear cutting blade assemblies 100C and 100B and the front and right cutting blade assemblies 100A and 100D, respectively, and relatively small gaps G1, G3, and G5 between other circles as described above. The inclusion of the offset V5 and the resultant non-symmetrical cutting blade assembly arrangement has been found to minimize the maximum width of an uncut swath when the mower 20 turns at its minimum or tightest turn radius. While the illustrated slope mower 20 has zero turn capability if the tracks 24 and 26 are driven in opposite directions, the typical tightest turn radius that will be experienced during normal operation will occur when one of the tracks is held static and the other is propelled. That radius is 19 inches in the present embodiment. This drawing shows that an uncut swath of maximum width “W” of 0.165″ is left under these circumstances. In fact, when the mower 20 with a minimum radius turns to the right as shown in FIG. 8, there is no uncut swath because the straight line cut gets front and right cutting blade assemblies 100A (BF) and 100D (BR) but is still cut by the rear cutting blade 100D (BB). Referring to FIG. 9, a relatively narrow uncut swath having a diameter of 0.165″ may remain after a minimum radius-left turn. Even vegetation in that path likely will be cut during a mowing operation due to the fact that vegetation tends to sway back and forth during a cutting operation, placing it in the path of a cutting blade.

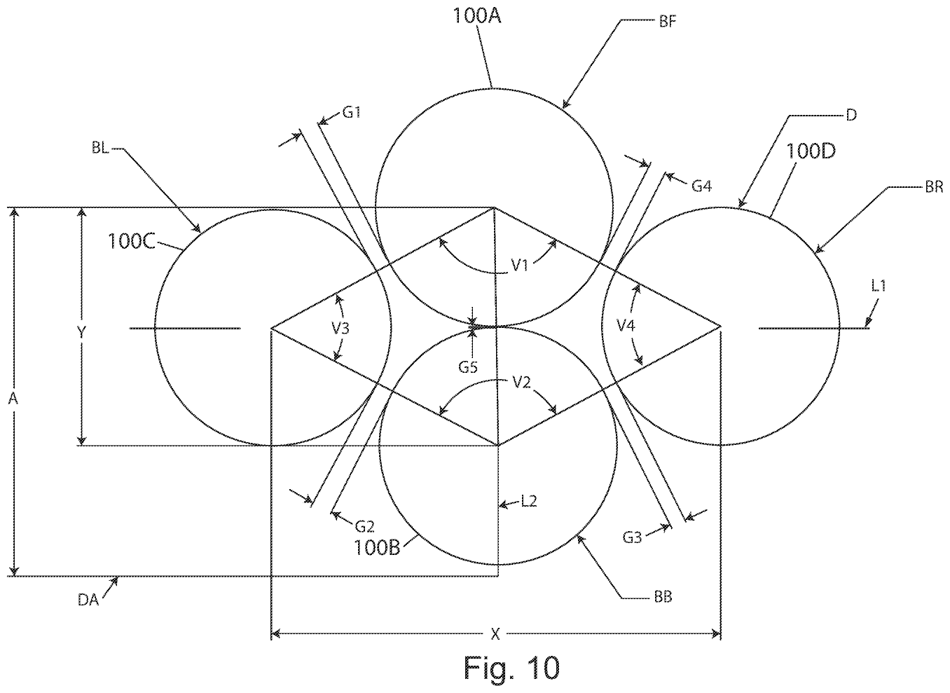

Referring to FIG. 10, the results described in connection with FIG. 9 are to be compared with a four cutting blade assembly configuration lacking the above-described offset V5, meaning that a line passing through the axes of front and rear cutting blade assemblies 100A and 100C lies on the longitudinal axis L2 of the slope mower 20. This results in a relatively large uniform gap G1-G4 of 1.3 inches between the circles circumscribed by each successive set of cutting blades. Those gaps are necessary in order to maintain the desired spacing X that is needed to provide the desired cutting swath (34″ in order to provide a 52″ cut in this example) between the centers of the circles BL and BR circumscribed by the left and right cutting blade assemblies 100C and 100D. These and other dimensions are as follows:
A=28.1″, longitudinal distance from center of BF to the line L2;
C=1.2, lateral distance from the center of BF to the vehicle longitudinal centerline CL;
Y=18.2″, distance from the center of BF to the center of BB;
X=34.0″; distance from the center of BL to the center of BR;
D=18.0″, diameter of BL, BR, BF, BB;
V1=124.0°; inclusion angle between the centers of BL and BR about the center of BF;
V2=124.0°, inclusion angle between the centers of BL and BR about the center of BB;
V3=56.0°, inclusion angle between the centers of BF and BB about the center of BL;
V4=56.0°, inclusion angle between the centers of BF and BB about the center BR;
V5=0°, offset angle of the line connecting the centers of BF and BB from the longitudinal centerline of the slope mower;
G1=1.3″, the gap between BL and BF;
G2=1.3″, the gap between BL and BB
G3=1.3″, the gap between BB and BR;
G4=1.3″ the gap between BR and BF; and
G5=0.2″, the gap between BF and BB.

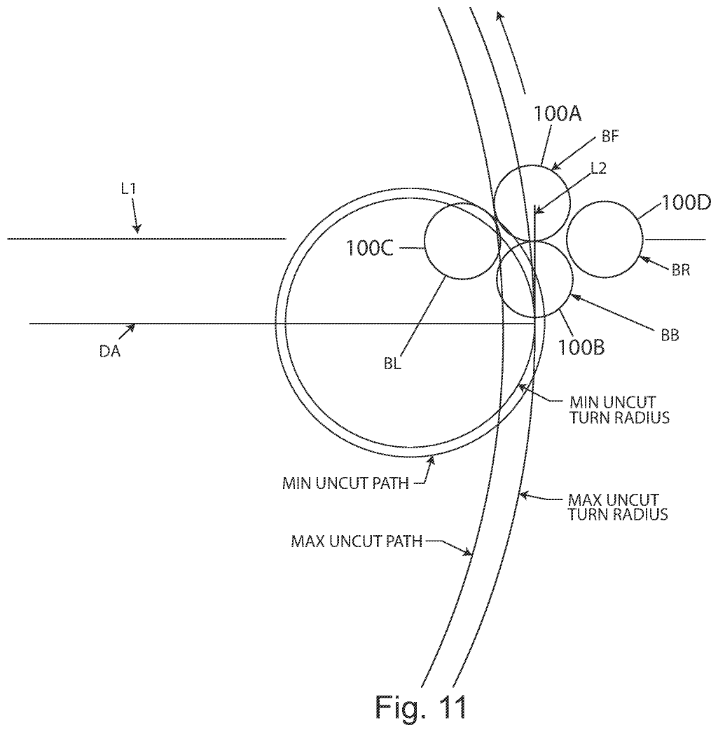

The maximum uncut swath resulting from a minimum radius turn in either direction is shown diagrammatically in FIG. 11. This drawing shows that an uncut swath of maximum width “W” of 1.27″ is left during a 19 inch turn in either direction. However, during anything other than the tightest turns, most or all of that width is covered by the rear blade assembly 100D during reverse travel or by the front cutting blade assembly 100A during forward travel.

The “effective cutting swath”, as defined by the path covered as the cutter deck 30 moves along a given path, therefore is improved in the configuration shown in FIGS. 7-9 as compared to the configuration shown in FIGS. 10 and 11. This applies whether the slope mower 20 moves forward or reverse.

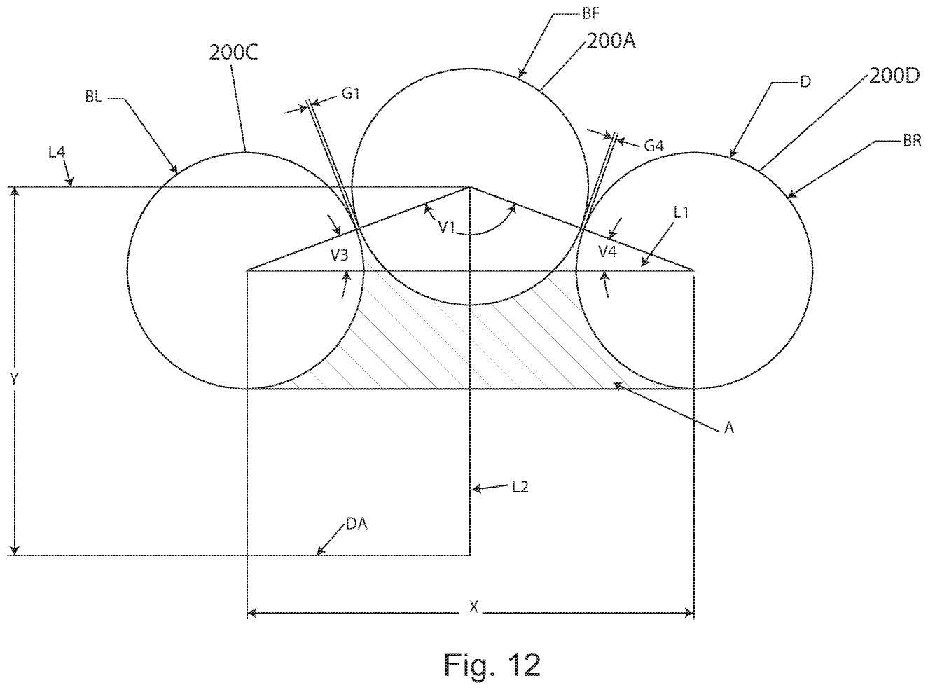

In further contrast, the corresponding geometry for a three-blade mower deck configured to cut the same 52″ swath is shown in FIG. 12. In that deck, the rear cutting blade assembly is omitted. A front cutting blade assembly 200A circumscribing a circle BF is flanked by left and right cutting blade assemblies 200C and 200D that are located behind the cutting blade assembly 200A and that circumscribe circles BL and BR, respectively. The centers of the cutting blade assemblies 200C and 200D lie on a line L1 that is parallel to the effective drive axis DA of the slope mower. These centers are disposed symmetrically from the longitudinal centerline L2 of the slope mower by a combined distance X. The line DA extends in parallel with the lateral centerline of the slope mower. The center of the front blade assembly 200A lies on the longitudinal centerline L2 of the slope mower 20 and is longitudinally offset from the vehicle drive axis DA by a distance Y. The resulting cutter deck has the following geometrical characteristics as denoted in FIG. 12:
Y=28.2″, the distance from the center of BF to DA;
X=34.0″, the distance from the center of BL to the center of BR;
D=18.0″, the diameter of each of BL, BR, BF;
V1=138.7°, the inclusion angle of the centers of BL and R about the center of BF;
V3=20.6°, the angle of the centers of BL and BF relative to L1;
V4=20.6°, the angle of the centers of BR and BF relative to L1;
G1=0.16″, the gap between BL and BF; and
G4=0.16″, the gap between BR and BF.

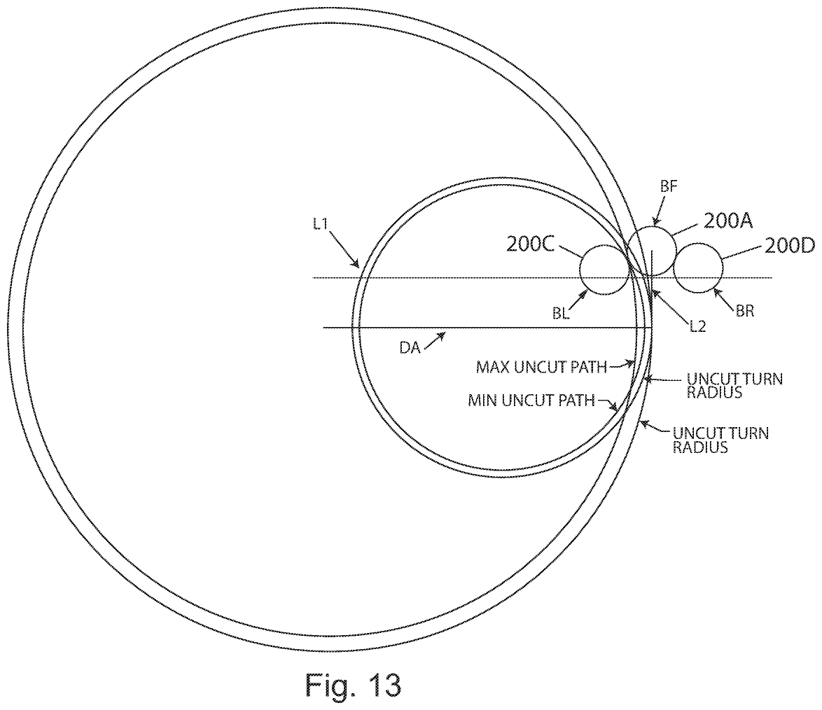

The maximum uncut swath resulting from the above-described 19 inch radius turn in either direction is shown diagrammatically in FIG. 13. This drawing shows that an uncut swath of maximum width “W” of 0.165″ is left during such a turn, the same as in the first “four blade assembly” embodiment of FIGS. 7-9. Hence, the offset V of the first embodiment approximates the small width W of the uncut swath that may be left during a sharp turn of a comparable three-bladed cutting deck having the same cutting width, yet cuts effectively in both the forward and reverse directions.

Comparing FIG. 7 or FIG. 10 to FIG. 12, providing the fourth or rear cutting blade assembly 100B provides at least two benefits. First, the rear cutting blade assembly 100B takes up much of a generally trapezoidal area A (FIG. 12 that remains uncut at the end of a cutting pass in the reverse direction. That area is over 950 in² in the case of a 52″ cutting deck. In contrast, either of the four cutting blade assembly configurations described above leaves two much smaller uncut areas on opposite sides of the rear cutting blade assembly 100B, having a smaller combined area of about 500 in² uncut. A sharp three-point turn that otherwise would be required to cut this area is largely obviated.

Second, the four cutting blade assembly arrangement of either FIG. 7 or FIG. 10 performs better during reverse travel than the three cutting blade assembly arrangement of FIG. 12. In the three-cutting blade assembly arrangement of FIG. 12, during reverse travel with counterclockwise rotating blade assemblies, the load imposed on the cutting blade assemblies 200A-200C increases progressively from right to left. Thus, grass is thrown from the path BR of the right cutting blade assembly 200D into the path BF of the front cutting blade assembly 200A, and the combined cuttings from both cutting blade assemblies 200D and 200A is then thrown into the path BL of the left cutting blade assembly 200C. This progressive loading tends to create windrows of cut vegetation when mowing in reverse rather than dispersing the cut vegetation relatively evenly along the width of the cut swath. The progressive loading also may cause the successive cutting blade assemblies 200A and 200C to become clogged and to bog down, reducing the quality of cut.

In contrast, when mowing in reverse with a four cutting blade assembly of FIG. 7 or FIG. 10, at least a substantial portion of the grass cut by the right cutting blade assembly 100D is thrown into the path of the rear cutting blade assembly 100B as opposed to the front blade assembly 100A, reducing or eliminating windrowing of cut vegetation and reducing the load on the front and left cutting blade assemblies 100A and 100C. During forward travel, the fourth or rear cutting blade assembly 100B serves as a “clean up” blade assembly that cuts any vegetation that bent over or otherwise left uncut by the other cutting blade assemblies, most notably the front cutting blade assembly 100A. This reduces or negates the need for a second, cleanup pass during mowing of heavy vegetation.

In operation, the operator manipulates controls on the remote controller 112 to first start the engine 28 and to enable cutting blade motor operation. The operator may also control cutting blade assembly rotational speed using the controller 112, or that speed may be constant or coupled to propulsion speed. The operator then manipulates joystick(s) or other controls in the remote controller 112 to cause the mower to cut vegetation while traveling along a slope of up to 50°. This cutting typically involves controlling the mower to mow in passes extending in the X direction and spaced from one another in the Y direction, as those directions are defined above. During this time, power is supplied to the main drive motors 50 from the battery bank 55 under control of the subcontrollers 60, and is supplied from the battery bank 55 to the cutting blade assembly drive motors 52 under control of the subcontrollers 62. The batteries 56 of the battery bank 55 are kept charged by the alternator 54 under power supplied by the engine 28.

At the end of a pass in the X direction, the operator may simply stop mower propulsion, turn the mower slightly to move it in the Y direction to align it along an uncut path adjacent the path that was just cut, and cut along that path by propelling the mower in the reverse X direction. The four cutting blade assembly configurations as described herein provide at least a generally equal quality of cut in both the forward and reverse directions without leaving uncut areas at the end of a given pass. This reduces or negates the need for sharp three point turns that could result in the tearing up of the ground by the tracks 24 and 26. If the blade assembly geometry of FIGS. 7-9 is employed, any uncut swath left behind during even very sharp turns is no wider than would remain while turning a mower equipped with a three-cutting blade assembly arrangement shown in FIGS. 12 and 13.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. A slope mower comprising:
a frame;
opposed ground supports supporting opposed lateral side portions of the frame on the ground;
a prime mover; and
a cutter deck supported on the frame and located, at least in part, beneath the frame, the cutter deck having four rotating cutting blade assemblies, wherein the cutting blade assemblies are arranged in a non-rectangular quadrilateral pattern when viewed in bottom plan.

2. The slope mower as recited in claim 1, wherein the cutting blade assemblies include first and second cutting blade assemblies disposed on opposed sides of a longitudinal centerline of the cutter deck, and third and fourth cutting blade assemblies located laterally between the first and second cutting blade assemblies and positioned in front of and behind a line connecting axes of rotations of the first and second cutting blade assemblies, respectively.

3. The slope mower as recited in claim 2, wherein each of the third and fourth cutting blade assemblies has an axis of rotation thereof that is positioned on the longitudinal centerline of the cutter deck.

4. The slope mower as recited in claim 2, wherein a line connecting the axes of rotation of the third and fourth cutting blade assemblies is offset relative to the longitudinal centerline of the cutter deck.

5. The slope mower as recited in claim 4, wherein an angle of the offset is between 5° and 15°.

6. The slope mower a recited in claim 5, wherein an angle of the offset is between 7° and 8°.

7. The slope mower as recited in claim 1, wherein the prime mover is an internal combustion engine, and wherein the slope mower is a hybrid vehicle having an alternator that is coupled to the internal combustion engine and having a battery bank that is charged by the alternator, and further comprising at least one electric motor that drives the cutting blade assemblies to rotate.

8. The slope mower as recited in claim 7, further comprising first through fourth electric motors that are supplied with power by the battery bank, wherein each of the first through fourth electric motors is configured to drive a dedicated one of the first through fourth cutting blade assemblies.

9. The slope mower as recited in claim 8, further comprising a main vehicle controller and first through fourth subcontrollers, each of which controls the power supply from the battery bank to a respective one of the electric motors.

10. The slope mower as recited in claim 7, wherein the engine, the alternator, the battery bank, and the electric motor are supported on the cutter deck.

11. The slope mower as recited with claim 1, further comprising first through fourth electric motors, each of which is configured to drive a dedicated one of the first through fourth cutting blade assemblies.

12. The slope mower as recited in claim 1, further comprising a remote control system including a remote controller located off-board the slope mower and a receiver located on-board the slope mower, the remote controller being operable, in response to inputs from an operator, to transmit control signals to the receiver that result in propulsion of the slope mower and operation of the cutting blade assemblies.

13. The slope mower as recited in claim 1, wherein the ground supports comprise tracks.

14. A cutter deck comprising:
an upper plate that is configured to be supported on a lawnmower;
first through fourth cutting blade assemblies that extend downwardly from the upper plate and that are arranged in a non-rectangular quadrilateral pattern when viewed in bottom plan.

15. The cutter deck as recited in claim 14, wherein the cutting blade assemblies include first and second cutting blade assemblies disposed on opposed sides of a longitudinal centerline of the cutter deck, and third and fourth cutting blade assemblies located laterally between the first and second cutting blade assemblies and positioned in front of and behind a line connecting axes of rotations of the first and second cutting blade assemblies, respectively.

16. The cutter deck as recited in claim 15, wherein each of the third and fourth cutting blade assemblies has an axis of rotation thereof that is positioned on the longitudinal centerline of the cutter deck.

17. The cutter deck as recited in claim 15, wherein a line connecting the axes of rotation of the third and fourth cutting blade assemblies is offset relative to the longitudinal centerline of the cutter deck.

18. The cutter deck as recited in claim 17, wherein an angle of the offset is between 5° and 15°.

19. The cutter deck as recited in claim 14, further comprising first through fourth electric motors, each of which is configured to supply power to a respective one of the first through fourth cutting blade assemblies.

20. A method of cutting vegetation, comprising:
propelling a lawnmower to move along an area to be mowed; and
during the propelling, cutting vegetation with first through fourth rotary cutting blade assemblies, wherein the cutting blade assemblies are arranged in a non-rectangular quadrilateral pattern when viewed in bottom plan.

21. The method as recited in claim 20, wherein the method includes cutting vegetation while traveling on an incline of between 25° and 50°.

22. The method as recited in claim 20, further comprising supplying power to the first through fourth cutting blade assemblies from first through fourth dedicated electric motors.

23. The method as recited in claim 20, further comprising controlling the lawnmower via a remote controller located off-board the lawnmower.
